(19) United States
(12) Patent Application Publication
(10) Pub. No.: US 2009/0195078 A1
(43) Pub. Date: Aug. 6, 2009

(54) INDUCTIVE ELECTRIC POWER STRUCTURE AND SYSTEM

(76) Inventors: Chienchung Lee, Taipei City (TW); Lushan Chang, Danshuei Township (TW); Shihwei Tung, Taipei City (TW); Kuoliang Lee, Taipei City (TW); Chihhao Chen, Dali City (TW); Hsiaoching Wang, Sindian City (TW)

Correspondence Address: KENING LI;PINSENT MASONS LLP, c/o FOUNTAIN LAW GROUP, INC, 18201 Von Karman Avenue, Suite 960, Irvine, CA, 92612, US

(21) Appl. No.: 12/362,861

(22) Filed: Jan. 30, 2009

(30) Foreign Application Priority Data
Feb. 1, 2008 (TW) 97104063

(51) Int. Cl. H01F 38/00

(52) U.S. Cl. 307/104

(57) ABSTRACT

An inductive electric power device which comprises an induction coil module and a power control module. The power control module is electrically connected to the induction coil module. The power control module comprises a main control module, a power output module, an interface module, a circuit protection module and a wireless identification module. The power output module, the interface module, the circuit protection module and the wireless identification module are electrically connected to the main control module respectively. The power output module is electrically connected to a household appliance, wherein the main control module drives the power output module to provide electrical power for the household appliance according to its power demand. The present invention also provides an inductive electric power system as a common platform of power supply for various household appliances with different power needs.

### CROSS REFERENCE TO RELATED APPLICATIONS

The present application claims priority to Republic of China Patent Application No. Serial No: 97104063, filed on Feb. 1, 2008, the entire disclosure of which is incorporated herein by reference.

### FIELD OF THE INVENTION

The present invention relates to electric power equipment, more particularly to inductive electric power equipment.

### RELATED ART

More and more household appliances enter people's lives which bring great convenience and comfort. Household appliances generally use electricity as power supply for functioning. These household appliances may use electricity directly from a wall plug, or be operated by batteries that are either rechargeable or non-rechargeable. Those that use rechargeable mode must be charged by a charger periodically. However, household appliances of different models often require their own chargers, partly due to the different power requirement. As the number of household appliances in the home increases, the number of chargers also increases, causing cluttering and wasting precious materials and other resources.

### SUMMARY OF THE INVENTION

The present invention provides an inductive electric power device and system, whose primary object is to overcome the disadvantages of the prior art where a different charger is needed for a different appliance. Such object of the present invention will become apparent in the ensuing description.

In one embodiment, the present invention provides an inductive electric power supply device, comprising:

an induction coil module; and

a power control module electrically connected to the induction coil module; wherein the power control module comprises a main control module, a power output module, an interface module, a circuit protection module and a wireless identification module; wherein the power output module, the interface module, the circuit protection module and the wireless identification module are electrically connected to the main control module respectively; and wherein the power output module is electrically connected to a household appliance, the main control module driving the power output module to provide electrical power for the household appliance equal to the power demand of it.

In another embodiment, the present invention provides an inductive electric power system, comprising

a battery module;

a magnetic control module connected to the battery module, wherein the magnetic control module comprises a first main control module, a coil-driving module, a first interface module, a first circuit protection module and a first wireless identification module, the coil-driving module, the first interface module, the first circuit protection module and the first wireless identification module electrically connected to the first main control module respectively;

a first induction coil module electrically connected to the coil-driving module;

a second induction coil module; and

a power control module electrically connected to the second induction coil module,

wherein the power control module comprises a second main control module, a power output module, a second interface module, a second circuit protection module and a second wireless identification module; wherein the power output module, the second interface module, the second circuit protection module and the second wireless identification electrically are connected to the second main control module respectively; wherein the power output module electrically connects to a household appliance, the first main control module provides appropriate electrical current to the first induction coil module via the first and second wireless identification module, the first induction coil module generates a magnetic force and the magnetic force passes through the second induction coil module to generate an inductive current and the inductive current is input to the power control module; and wherein the second main control module drives the power output module to provide electric power for household appliance equal to the power demand of the household appliance.

Compared to related art, the power supply device and system present invention have the following advantages. The first main control module provides an appropriate electrical current to the first induction coil module via the first and second wireless identification module, the first induction coil module generates a magnetic force and the magnetic force passes through the second induction coil module to generate an inductive current and the inductive current is input to the power control module. The second main control module drives the power output module to provide electric power for a household appliance equal to the power demand of the household appliance. Thus, the power supply of the present invention provides a common power supply platform for all household appliances, and overcomes the disadvantages of the prior art that requires different power plugs for different appliances.

### BRIEF DESCRIPTION OF THE DRAWINGS

Following are further descriptions according to drawings and embodiments.

FIG. 1 is a block diagram of an inductive electric power structure of the present invention.

FIG. 2 is a block diagram of an inductive electric power system of the present invention.

FIG. 3 is a structure sketch map of FIG. 2

FIG. 4 is a block diagram of the inductive electric power system according to one embodiment of the present invention.

FIG. 5 is a block diagram of the inductive electric power system according to another embodiment of the present invention.

FIG. 6 is a structure sketch map of FIG. 5

FIG. 7 is a block diagram of the inductive electric power system in embodiment 4 of the present invention.

In the FIGS., the following components or parts are described: induction coil module 1; power control module 2; main control module 21; power output module 22; interface module 23; power monitor unit 231; monitor unit 232; operator unit 233; circuit protection module 24; over-voltage protection unit 241; over-current protection unit 242; overheat protection unit 243; wireless identification module 25; household appliance 3; battery module 4; power supply unit 41; voltage transformation unit 42; power storage unit 43; magnetic control module 5; first main control module 51; coil-driving module 52; first interface module 53; first monitor unit 531; first operator unit 532; first circuit protection module 54; first over-voltage protection unit 541; first over-current protection unit 542; first overheat protection unit 543; first wireless identification module 55; coil-detecting module 56; power management module 57; first induction coil module 6; main induction unit 61; secondary induction unit 62; second induction coil module 7; power control module 8; second main control module 81; power output module 82; second interface module 83; power monitor unit 831; second monitor unit 832; second operator unit 833; second circuit protection module 84; second over-voltage protection unit 841; second over-current protection unit 842; second overheat protection unit 843; second wireless identification module 85.

### DETAILED DESCRIPTION OF EXEMPLARY EMBODIMENTS

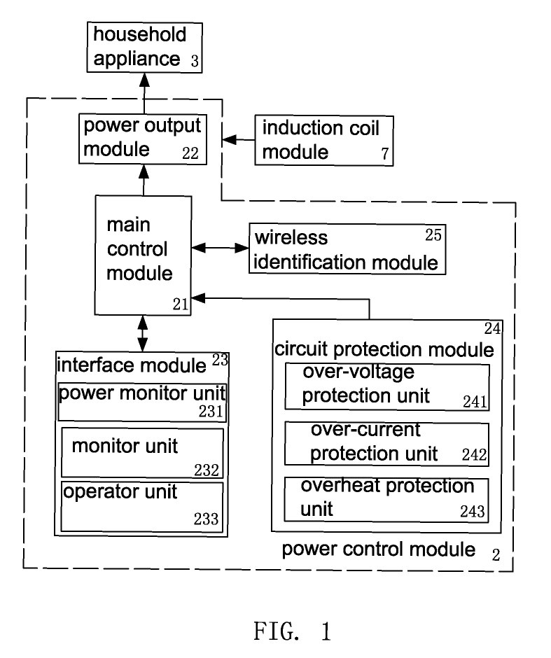

As shown in FIG. 1, an inductive electric power structure of the present invention comprises an induction coil module 1 and a power control module 2. The power control module 2 is electrically connected to the induction coil module 1. The power control module 2 comprises a main control module 21, a power output module 22, an interface module 23, a circuit protection module 24 and a wireless identification module 25. The power output module 22, the interface module 23, the circuit protection module 24 and the wireless identification module 25 are electrically connected to the main control module 21. The power output module 22 is electrically connected to a household appliance 3. When a magnetic field passes through the induction coil module 1, the induction coil module generates an inductive current and the inductive current is provided to the power control module 2. The main control module 21 drives the power output module 22 to provide electric power for household appliance 3 equal to the power demand of the household appliance.

The interface module 23 comprises a power monitor unit 231, a monitor unit 232 and an operator unit 233. The power monitor unit 231 displays the level of consumed power by household appliance 3. The monitor unit 232 shows whether the power control module 2 is supplying power for household appliance 3. A user can control whether power is supplied to household appliance 3 via the operator unit 233. The circuit protection module 24 comprises an over-voltage protection unit 241, an over-current protection unit 242 and an overheating protection unit 243. The over-voltage protection unit 241, the over-current protection unit 242 and the overheating protection unit 243 protect the power control module 2 from over-voltage, over-current or overheating respectively to prolong its service life.

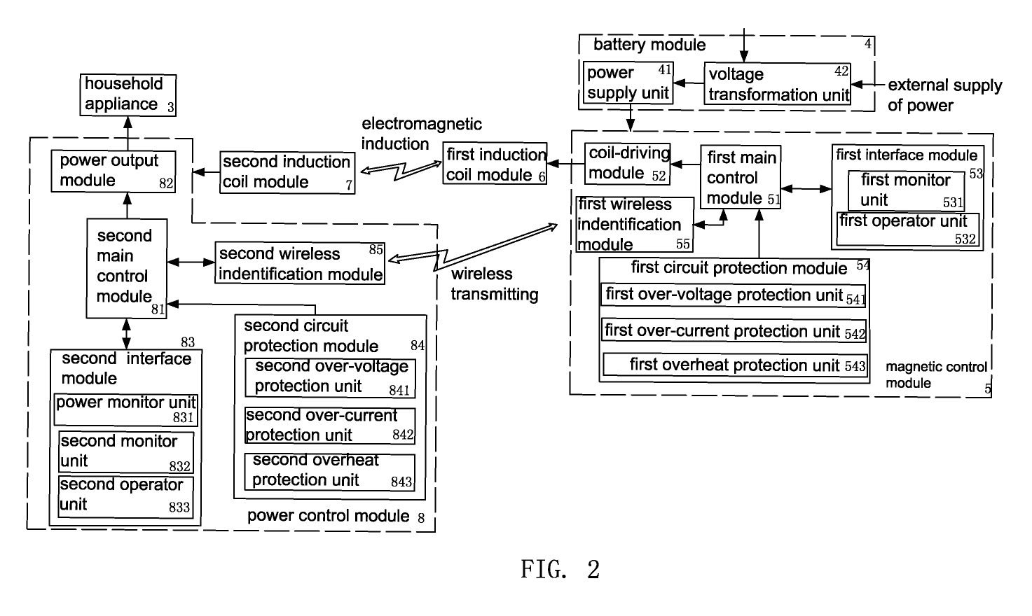

As shown in FIG. 2, an inductive electric power system of the present invention comprises a battery module 4, a magnetic control module 5, a first induction coil module 6, a second induction coil module 7 and a power control module 8. The battery module 4 comprises a power supply unit 41 and a voltage transformation unit 42. The power supply unit 41 is electrically connected to the voltage transformation unit 42 and the magnetic control module 5. The voltage transformation unit 42 is electrically connected to an external alternate current or direct current source. The voltage transformation unit 42 is used to change the external alternate current to direct current or to alter the voltage.

As shown in FIG. 2, the magnetic control module 5 comprises a first main control module 51, a coil-driving module 52, a first interface module 53, a first circuit protection module 54 and a first wireless identification module 55. The coil-driving module 52, the first interface module 53, the first circuit protection module 54 and the first wireless identification module 55 are electrically connected to the first main control module 51 respectively. The coil-driving module 52 is electrically connected to the first induction coil module 6. The coil-driving module 52 is used to supply current for the first induction coil module 6.

As shown in FIG. 2, the first interface module 53 comprises a first monitor unit 531 and a first operator unit 532. The first monitor unit 531 shows whether the magnetic control module 5 is supplying electrical current for the first induction coil module 6. Users can determine whether to supply power for the first induction coil module 6 via the first operator unit 532. The first circuit protection module 54 comprises a first over-voltage protection unit 541, a first over-current protection unit 542 and a first overheating protection unit 543. The first over-voltage protection unit 541, the first over-current protection unit 542 and the first overheating protection unit 543 protect the magnetic control module 5 out of over-voltage, over-current or overheat respectively to prolong its service life.

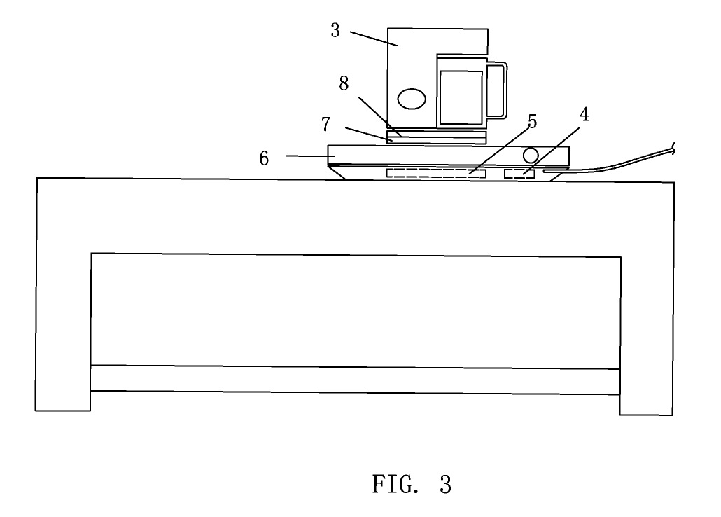

As shown in FIGS. 2 and 3, the power control module 8 comprises a second main control module 81, a power output module 82, a second interface module 83, a second circuit protection module 84 and a second wireless identification module 85. The power output module 82, the second interface module 83, the second circuit protection module 84 and the second wireless identification module 85 are electrically connected to the second main control module 81 respectively. The power output module 82 is electrically connected to household appliance 3. The second interface module 83 comprises a power monitor unit 831, a second monitor unit 832 and a second operator unit 833. The second circuit protection module 84 comprises a second over-voltage protection unit 841, a second over-current protection unit 842 and a second overheat protection unit 843.

As shown in FIGS. 2 and 3, the battery module 4 supplies power to the magnetic control module 5. The first wireless identification module 55 matches with the second wireless identification module 85 to form an information wireless transmitting path. The first main control module 51 obtains information about the power need of household appliance 3 via the information wireless transmitting path. The first main control module 51 provides appropriate electrical current to the first induction coil module 6 via the information wireless transmitting path. The first induction coil module 6 generates a magnetic force filed which passes through the second induction coil module 7 to generate an inductive current and the inductive current is input to the power control module 8. The second main control module 81 drives the power output module 82 to provide electric power for household appliance 3 equal to the power demand of the household appliance 3.

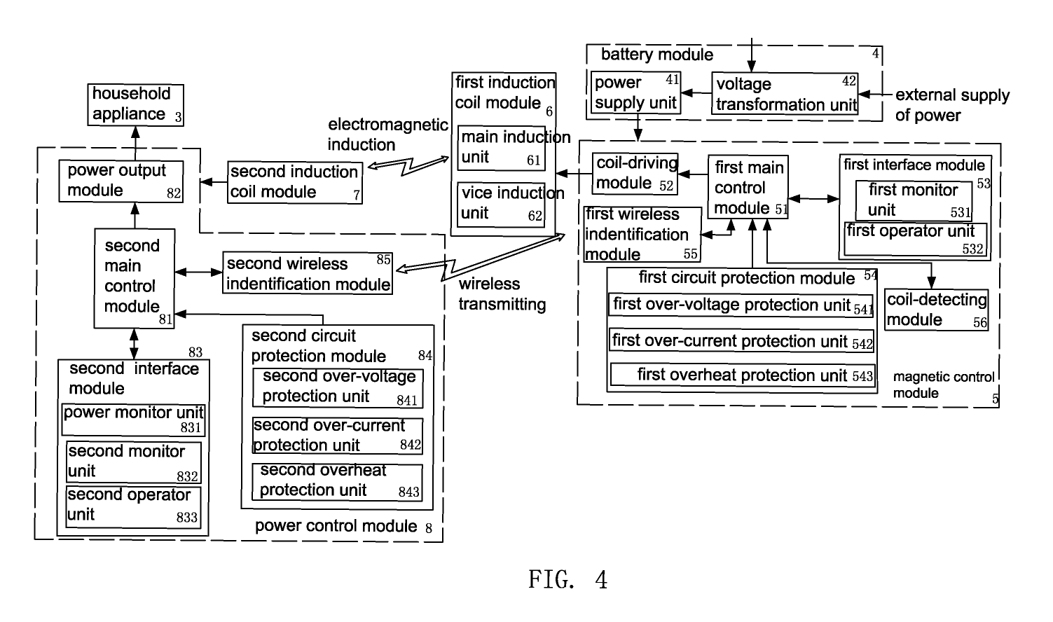

As shown in FIG. 4, the magnetic control module 5 also comprises a coil-detecting module 56; the coil-detecting module 56 is electrically connected to the first main control module 51. The first induction coil module 6 comprises a main induction unit 61 and a secondary induction unit 62. The main induction unit 61 is electrically connected to the coil-driving module 52. The secondary induction unit 62 is electrically connected to the coil-detecting module 56. The secondary induction unit 62 brings electromagnetic induction with the second induction coil module 7 to form another information wireless transmitting path.

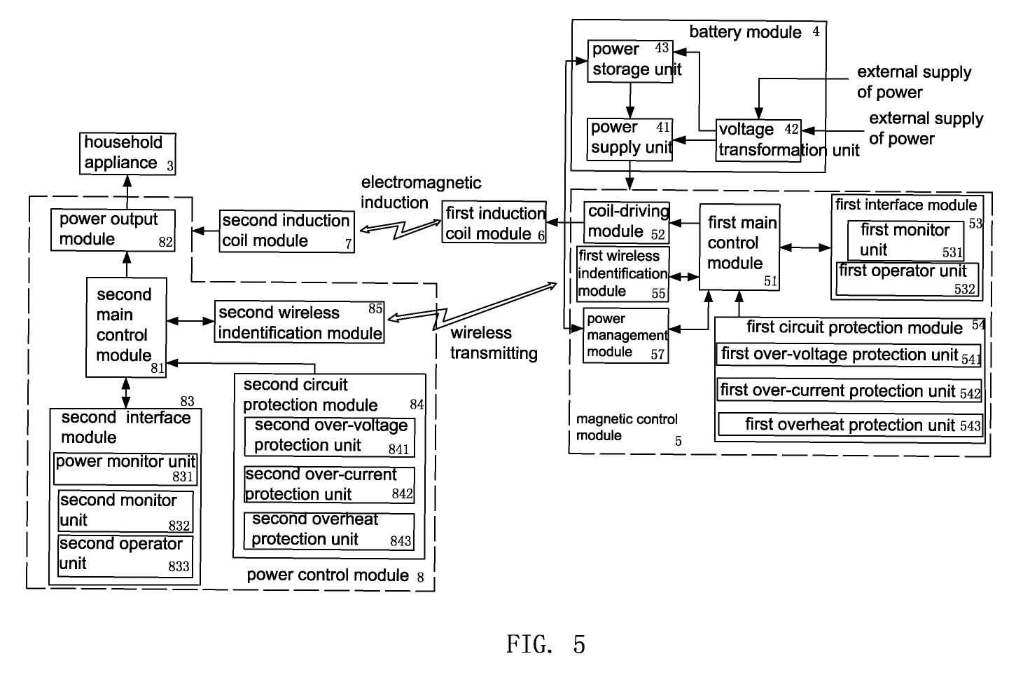

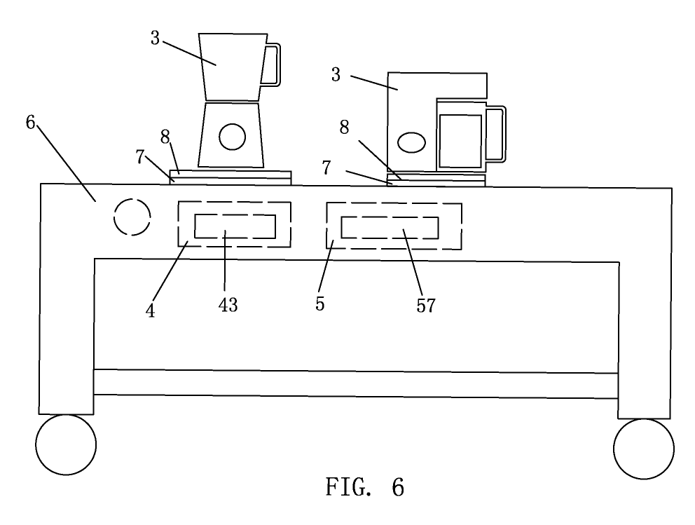

As shown in FIGS. 5 and 6, the battery module 4 also comprises a power storage unit 43. The voltage transformation unit 42 is electrically connected to the power storage unit 43. The power storage unit 43 is electrically connected to the power supply unit 41. The magnetic control module 5 comprises a power management module 57. The power management module 57 is electrically connected to the power storage unit 43 and the first main control module 51. During non-peak hours of electricity usage, energy is stored in the power storage unit 43, and during peak electricity usage time, the power stored in the power storage unit is supplied to household appliance 3, saving power cost.

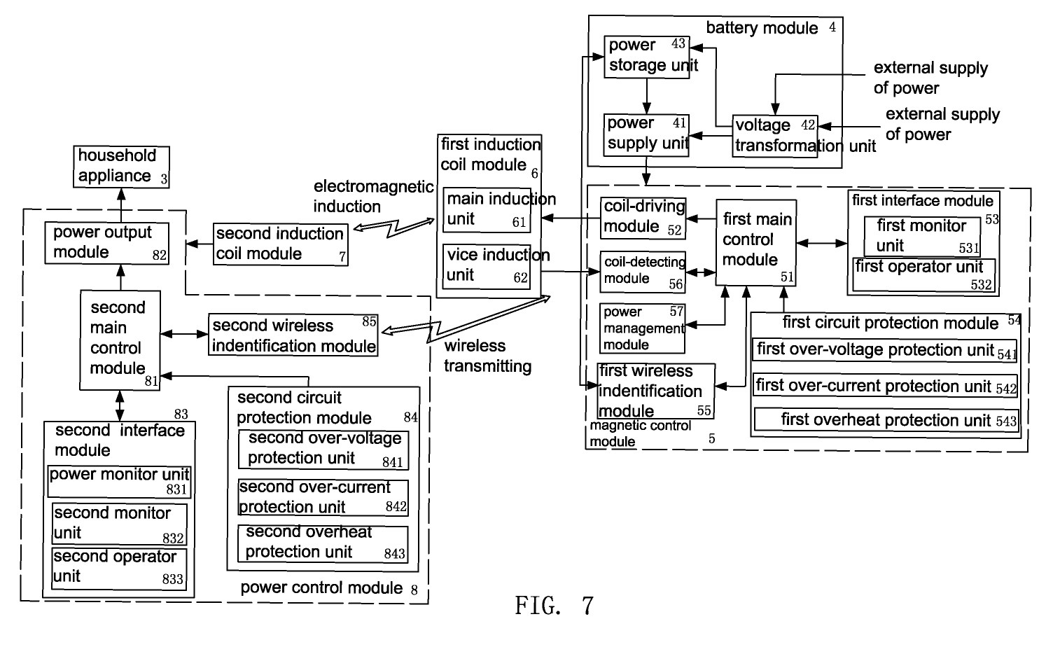

As shown in FIG. 7, the battery module 4 comprises power storage unit 43. The magnetic control module 5 comprises the coil-detecting module 56 and power management module 57. The first induction coil module 6 comprises main induction unit 61 and secondary induction unit 62.

The inductive electric power structure and system of the present invention have advantages as follows.

1. The first main control module 51 can get the information that household appliance 3 need power and the amount of power needed. The power that the power output module 82 supplies is controlled so as to be equal to the power demand of the household appliance 3. This allows the inductive electric power system of the present invention to supply power to all kinds of household appliances with various power needs, providing a common platform of power supply for all household appliance and overcomes the disadvantages of the prior art power supplies which must be tailored to the needs of individual appliances.

2. The power management module 57 is electrically connected to the power storage unit 43 and the first main control module 51. Thus, during non-peak electricity usage time, electric power is stored in the power storage unit 43, and during peak electricity usage time, the power stored in the power storage unit is supplied for household appliance 3, saving power cost.

The foregoing description of the exemplary embodiment of the invention has been presented for the purposes of illustration and description. It is not intended to be exhaustive or to limit the invention to the precise form disclosed. Many modifications and variations are possible in light of the above teaching. All changes that come within the meaning and range of equivalency of the claims are to be embraced within their scope.

What is claimed is:

1. An inductive electric power supply device, comprising:
an induction coil module; and
a power control module electrically connected to the induction coil module,
wherein the power control module comprises a main control module, a power output module, an interface module, a circuit protection module and a wireless identification module; wherein the power output module, the interface module, the circuit protection module and the wireless identification module are electrically connected to the main control module respectively; and wherein the power output module electrically connects to a household appliance, the main control module drives the power output module to provide electrical power to the household appliance according to its power demand.

2. The inductive electric power supply device according to claim 1, wherein the interface module comprises a monitor unit and an operator unit.

3. The inductive electric power supply device according to claim 1, wherein the circuit protection module comprises an over-voltage protection unit, an over-current protection unit and an overheating protection unit.

4. An inductive electric power system, comprising:
a battery module;
a magnetic control module connected to the battery module, wherein the magnetic control module comprises a first main control module, a coil-driving module, a first interface module, a first circuit protection module and a first wireless identification module, and wherein the coil-driving module, the first interface module, the first circuit protection module and the first wireless identification module are electrically connected to the first main control module respectively;
a first induction coil module electrically connected to the coil-driving module;
a second induction coil module; and
a power control module electrically connected to the second induction coil module, wherein the power control module comprises a second main control module, a power output module, a second interface module, a second circuit protection module and a second wireless identification module; wherein the power output module, the second interface module, the second circuit protection module and the second wireless identification are electrically connected to the second main control module respectively; wherein the power output module is electrically connected to a household appliance, the first main control module provides appropriate electrical current to the first induction coil module via the first and second wireless identification module, the first induction coil module generates a magnetic force field which passes through the second induction coil module to generate an inductive current which is input to the power control module, the second main control module drives the power output module to provide electric power to the household appliance equal to the power demand of the household appliance.

5. The inductive electric power system according to claim 4, wherein the first interface module comprises a first monitor unit and a first operator unit.

6. The inductive electric power system according to claims 4, wherein the first circuit protection module comprises a first over-voltage protection unit, a first over-current protection unit and a first overheating protection unit.

7. The inductive electric power system according to claim 4, wherein the magnetic control module further comprises a coil-detecting module electrically connected to the first main control module; the first induction coil module comprises a main induction coil unit and a secondary induction coil unit, wherein the main induction coil unit is electrically connected to the coil-driving module and the secondary induction coil unit is electrically connected to the coil-detecting module.

8. The inductive electric power system according to claim 4, wherein the battery module further comprises a power supply unit and a voltage transformation unit, wherein the power supply unit is electrically connected to the voltage transformation unit and the magnetic control module, and the voltage transformation unit electrically connected to external alternate current or external direct current.

9. The inductive electric power system according to claim 4, wherein the battery module further comprises a power storage unit electrically connected to the voltage transformation unit and the power supply unit, and the magnetic control module further comprises a power management module electrically connected to the first main control module.

10. The inductive electric power system according to claim 4, wherein the second interface module comprises a power monitor unit, a second monitor unit and a second operator unit.

11. The inductive electric power system according to claim 4, wherein the second circuit protection module comprises a second over-voltage protection unit, a second over-current protection unit and a second overheating protection unit.

12. The inductive electric power system according to claim 7, wherein the battery module further comprises a power supply unit and a voltage transformation unit, wherein the power supply unit is electrically connected to the voltage transformation unit and the magnetic control module, and the voltage transformation unit electrically connected to external alternate current or external direct current.

13. The inductive electric power system according to claim 7, wherein the battery module further comprises a power storage unit electrically connected to the voltage transformation unit and the power supply unit, and the magnetic control module further comprises a power management module electrically connected to the first main control module.
